(19) United States
(12) Patent Application Publication
(10) Pub. No.: US 2012/0045952 A1
(43) Pub. Date: Feb. 23, 2012

(54) Thermochromic textile material

(76) Inventor: Ming-Tse Chen, Taipei (TW)

(21) Appl. No.: 12/859,764

(22) Filed: Aug. 19, 2010

(51) Int. Cl. B32B 5/02

(52) U.S. Cl. 442/1

(57) ABSTRACT

A thermochromic textile material includes a top anti-UV (ultraviolet) layer; a membrane layer below the anti-UV layer; an intermediate layer assembly below the membrane layer; and a bottom layer of transparent mesh cloth. In one embodiment the intermediate layer assembly includes an upper adhesive and a lower thermochromic pigment layer. In another embodiment the intermediate layer assembly comprises an upper thermochromic pigment layer and a lower adhesive.

### BACKGROUND OF THE INVENTION

1. Field of Invention

The invention relates to thermochromic materials and more particularly to a thermochromic textile material with improved characteristics

2. Description of Related Art

Thermochromism is the ability of substance to change color due to a change in temperature. A mood ring is an excellent example of this, but it has many other uses such as baby bottles (changes to a different color when cool enough to drink) and kettles.

Clothes made of thermochromic textile material are well known. For example, there are T-shirts having a portion which has a different color in response to heat (e.g., heat generated by hairdryer). However, their quality is poor. Thus, the need for improvement still exists.

### SUMMARY OF THE INVENTION

It is therefore one object of the invention to provide a thermochromic textile material comprising a top anti-UV (ultraviolet) layer; a membrane layer below the anti-UV layer; an intermediate layer assembly below the membrane layer; and a bottom layer of transparent mesh cloth, wherein the intermediate layer assembly either comprises an upper adhesive and a lower thermochromic pigment layer or comprises an upper thermochromic pigment layer and a lower adhesive.

The above and other objects, features and advantages of the invention will become apparent from the following detailed description taken with the accompanying drawings.

### BRIEF DESCRIPTION OF THE DRAWINGS

FIG. 1 is a perspective view of a tent having layers of fabric made of a first preferred embodiment of thermochromic textile material according to the invention;

FIG. 2 is a perspective view of a shower curtain having layers of fabric made of a second preferred embodiment of thermochromic textile material according to the invention;

FIG. 3 is a flow chart illustrating a process of manufacturing the first preferred embodiment of thermochromic textile material;

FIG. 4 is a flow chart illustrating a process of manufacturing the second preferred embodiment of thermochromic textile material;

FIG. 5 plots UV adsorption percentage versus color-changing percentage of tent or shower curtain for tent or shower curtain of the invention; and

FIG. 6 is a table showing UV adsorption percentage and color change versus color-changing percentage of tent or shower curtain expressed by Cartesian coordinate according to the invention.

### DETAILED DESCRIPTION OF THE INVENTION

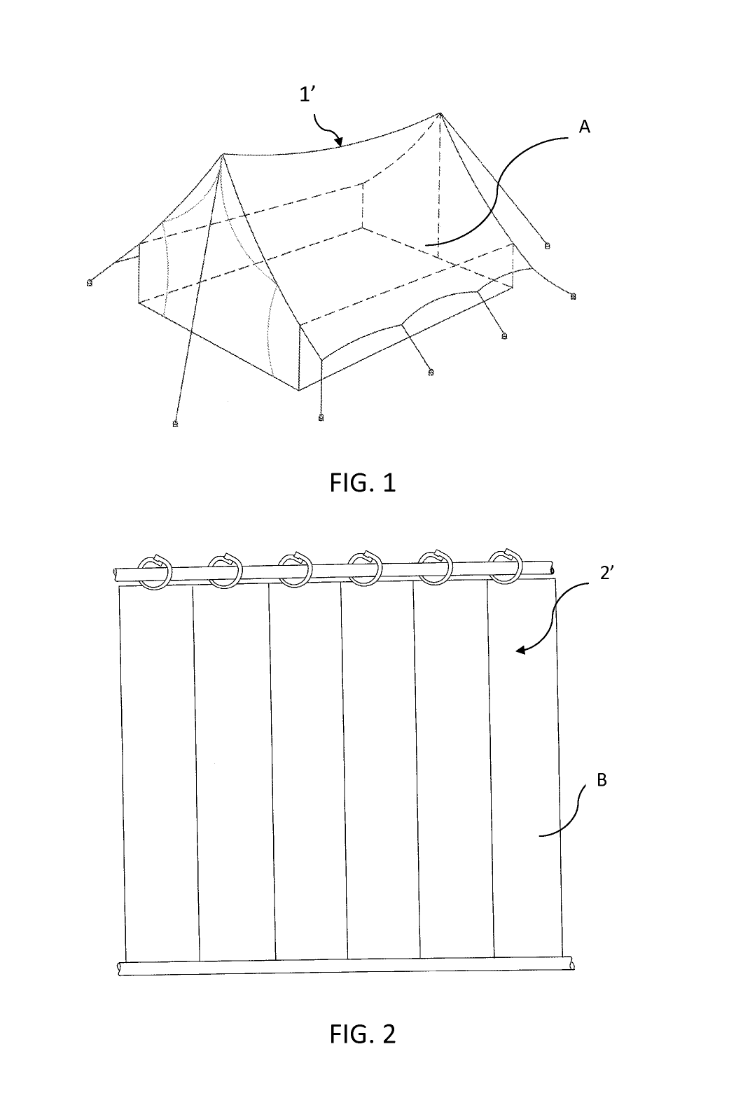

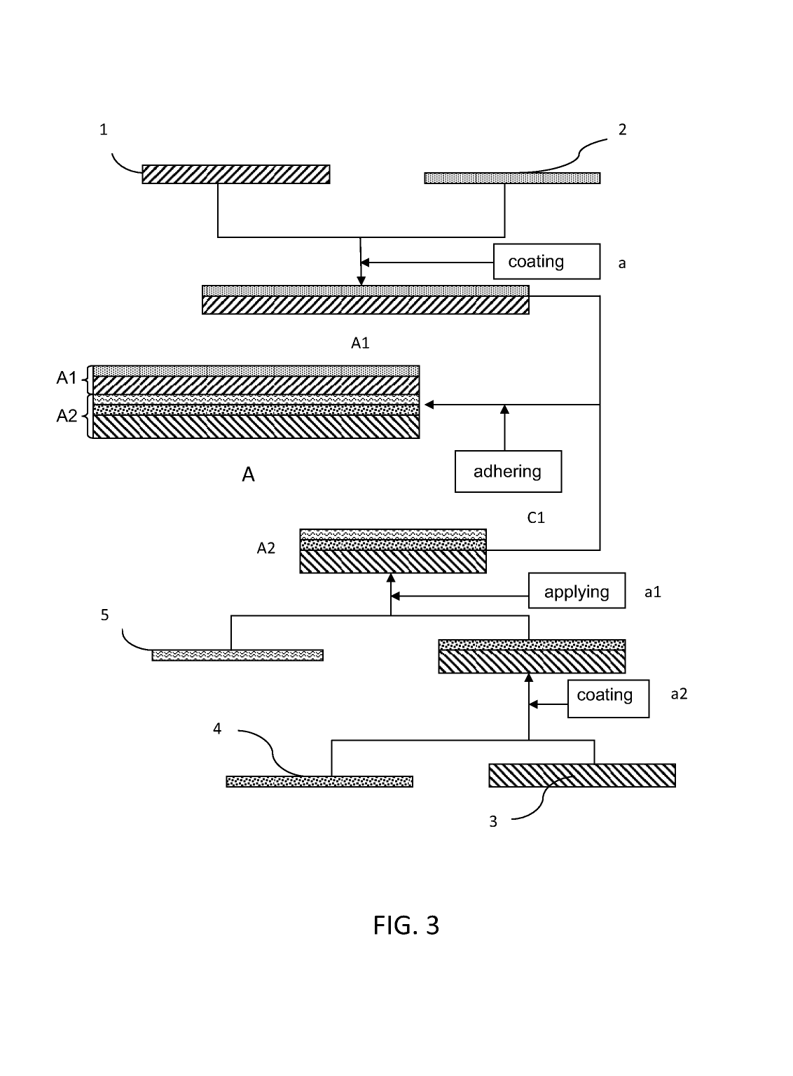

Referring to FIGS. 1 and 3, a thermochromic textile material A in accordance with a first preferred embodiment of the invention is discussed in detail below. A tent 1′ is made of the thermochromic textile material A. The thermochromic textile material A can be produced by coating an anti-UV (ultraviolet) layer 2 on a membrane layer 1 to form a first structural layer A1 (step a of coating), coating a thermochromic pigment layer 4 on a layer of transparent mesh cloth 3 (step a2 of coating), applying adhesive 5 on the thermochromic pigment layer 4 to form a second structural layer A2 (step al of applying), and finally adhering the first structural layer A1 onto the second structural layer A2 (step c1 of adhering). The membrane layer 1 is selected from a group consisting of PET (polyethylene terephthalate), TPU (thermoplastic polyurethane), PTFE (polytetrafluoroethylene), TPE (thermoplastic elastomer), PU (polyurethane), and PP (polypropylene) and has a thickness between 8 μm and 25 μm. The layer of transparent mesh cloth 3 is either nylon or polyester fiber.

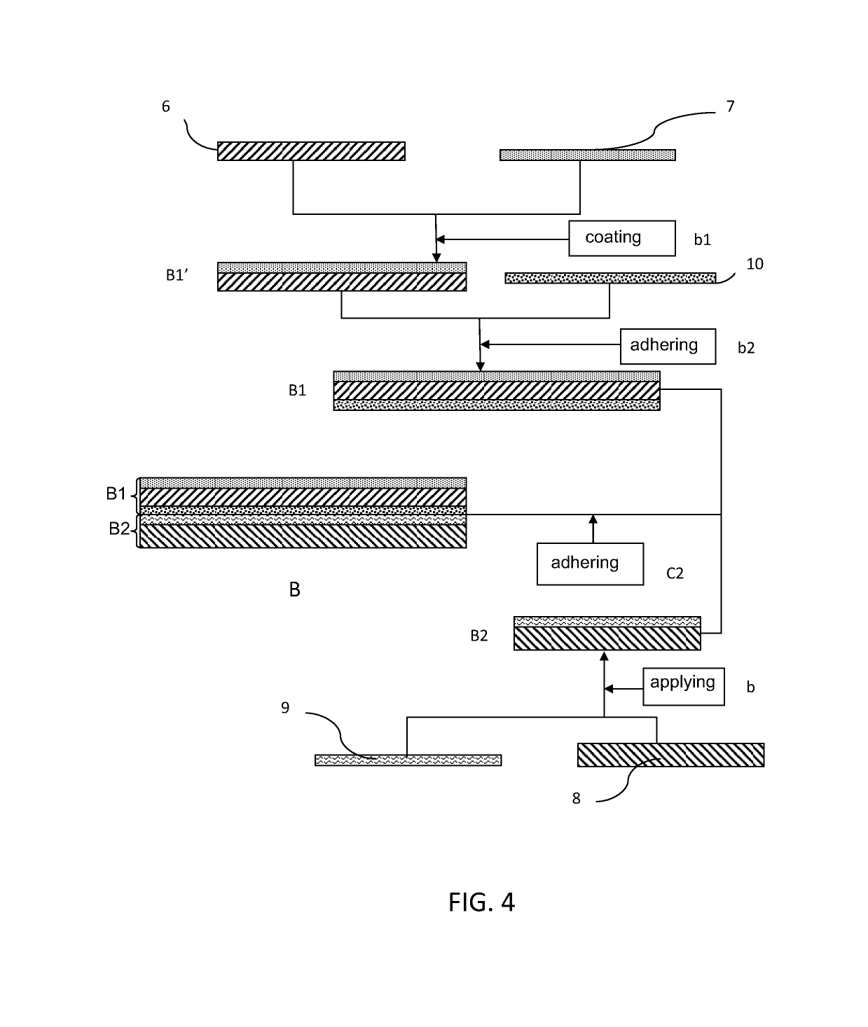

Referring to FIGS. 2 and 4, a thermochromic textile material B in accordance with a second preferred embodiment of the invention is discussed in detail below. A shower curtain 2′ is made of the thermochromic textile material B. The thermochromic textile material B can be produced by coating an anti-UV layer 7 on a membrane layer 6 to form a first structure layer B1′ (step b1 of coating), adhering the first structure layer B1′ onto a thermochromic pigment layer 10 to form a second structure layer B1 (step b2 of adhering), applying adhesive 9 on a layer of transparent mesh cloth 8 to form a third structure layer B2 (step b of applying), and finally adhering the second structure layer B1 onto the third structure layer B2 (step c2 of adhering). The membrane layer 6 is selected from a group consisting of PET, TPU, PTFE, TPE, PU, and PP and has a thickness between 8 μm and 25 μm. The layer of transparent mesh cloth 3 is either nylon or polyester fiber.

While the tent 1′ is made of the thermochromic textile material A and the shower curtain 2′ is made of the thermochromic textile material B, it is understood that the tent 1′ can be made of the thermochromic textile material B and the shower curtain 2′ can be made of the thermochromic textile material A in other embodiments without departing from the scope of the invention.

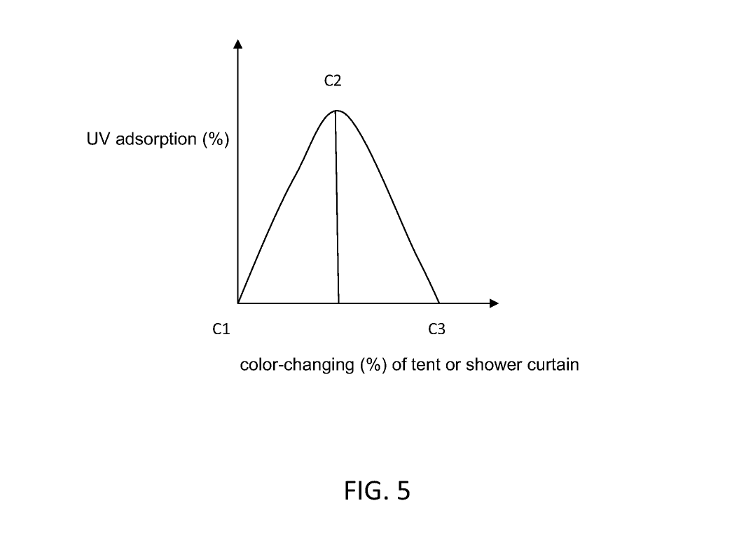

Referring to FIG. 5, it plots UV adsorption percentage (Y coordinate) versus color-changing percentage of tent or shower curtain for tent or shower curtain (X coordinate). At point C1 (e.g., prior to dawn), the UV adsorption percentage is about 0% and thus color of the tent or shower curtain is transparent. UV adsorption percentage increases as the sun rises. At point C2 (e.g., noon), the UV adsorption percentage is about 100% and color of the tent or shower curtain changes to dark (e.g., green) (i.e., about 50% of the total color change phase of the tent or shower curtain). UV adsorption percentage decreases as the sun begins to set (e.g., afternoon). At point C3 (e.g., dusk), the UV adsorption percentage is about 0% and color of the tent or shower curtain changes to transparent (i.e., about another 50% of the total color change phase of the tent or shower curtain).

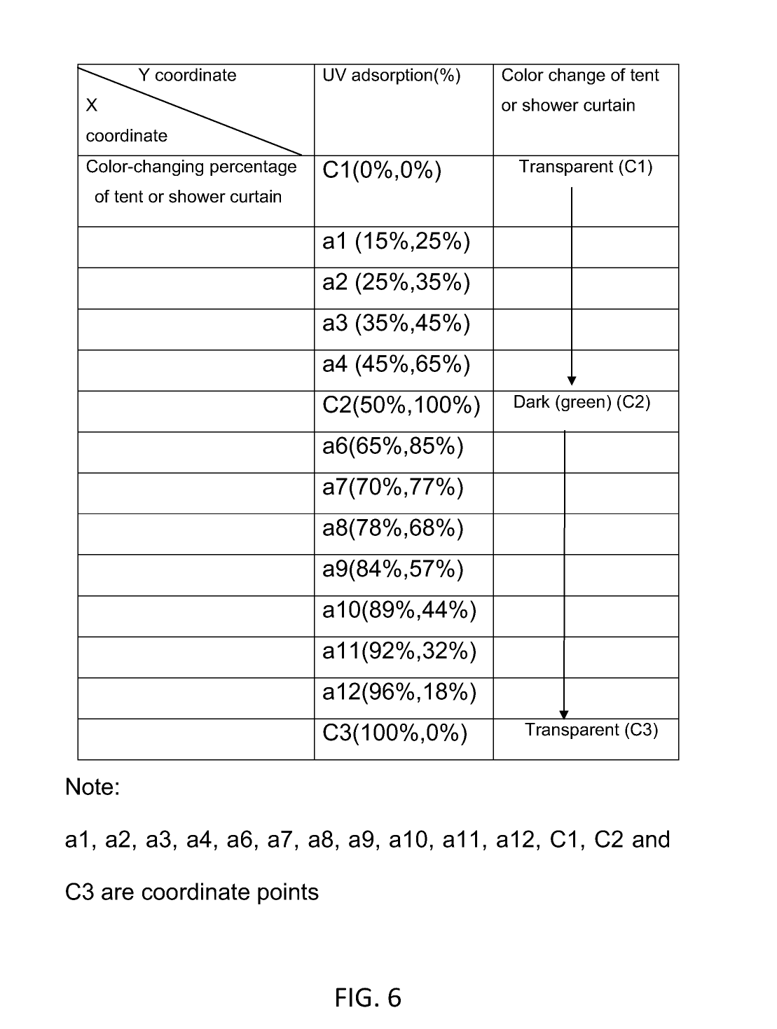

In one exemplary example, an anti-UV layer (about 12 μm) is coated on a membrane layer (e.g., PP layer) to form a first structural layer, coating a thermochromic pigment layer on a layer of transparent mesh cloth (e.g., nylon), applying adhesive having a thickness about 0.5 mm on the thermochromic pigment layer to form a second structural layer, and finally adhering the first structural layer onto the second structural layer to produce a thermochromic textile material which is cut to a number of units of predetermined size. Each unit is the material for manufacturing a layer of tent or shower curtain which is subjected to daylight from sunrise to sunset. Color change of the tent or shower curtain is detailed in the table of FIG. 6.

While the invention has been described in terms of preferred embodiments, those skilled in the art will recognize that the invention can be practiced with modifications within the spirit and scope of the appended claims.

What is claimed is:

1. A thermochromic textile material comprising:
a top anti-UV (ultraviolet) layer;
a membrane layer below the anti-UV layer;
an intermediate layer assembly below the membrane layer; and
a bottom layer of transparent mesh cloth,
wherein the intermediate layer assembly either comprises an upper adhesive and a lower thermochromic pigment layer or comprises an upper thermochromic pigment layer and a lower adhesive.

2. The thermochromic textile material of claim 1, wherein the membrane layer is selected from a group consisting of PET (polyethylene terephthalate), TPU (thermoplastic polyurethane), PTFE (polytetrafluoroethylene), TPE (thermoplastic elastomer), PU (polyurethane), and PP (polypropylene).

3. The thermochromic textile material of claim 1, wherein the layer of transparent mesh cloth is nylon.

4. The thermochromic textile material of claim 1, wherein the layer of transparent mesh cloth is polyester fiber.

5. The thermochromic textile material of claim 1, wherein the membrane layer has a thickness between 8 μm and 25 μm.
